(19) United States
(12) Patent Application Publication
(10) Pub. No.: US 2010/0010755 A1
(43) Pub. Date: Jan. 14, 2010

(54) METHOD FOR DIAGNOSING AN IMPULSE LINE BLOCKAGE IN A PRESSURE TRASDUCER, AND PRESSURE TRANSDUCER

(76) Inventor: Christoph Paulitsch, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/309,453

(22) PCT Filed: Jul. 20, 2006
(86) PCT No.: PCT/EP2006/007172

§ 371 Date: Jul. 10, 2009

(51) Int. Cl. G01F 1/34

(52) U.S. Cl. 702/47; 73/861.42

(57) ABSTRACT

A method for the detection of diagnosis of a blockage of an impulse line in a pressure measurement transducer and a corresponding pressure measurement transducer are disclosed, in which at least one characteristic value is compared with at least one reference value for the analysis of at least one measurement signal and, depending on the result of the comparison, an action is triggered, wherein the, or every, characteristic value is produced, with the aid of at least single parameters of a model describing the transmission behavior of impulse lines with which the pressure measurement transducer is coupled to a line traversed by a fluid.

### CROSS REFERENCE TO RELATED APPLICATIONS

This application is the US National Stage of International Application No. PCT/EP2006/007172 filed Jul. 20, 2006 and claims the benefit thereof.

### FIELD OF INVENTION

The invention relates to a method for diagnosing an impulse line blockage in a (pressure) transducer, and a (pressure) transducer which is prepared and designed for implementing the method. Pressure transducers are known per se and are designed in particular for measuring pressure changes at a point of discontinuity, e.g. a so-called orifice meter, in a pipe through which a liquid or a gas (fluid) flows. Such pressure changes are detected via pressure differences arising at the orifice meter. Flow rate measurement is also possible on the basis of differential pressure measurement of this kind.

### BACKGROUND OF INVENTION

The pressure transducer incorporates, as a sensing element, a pressure sensor which is coupled to a region upstream and downstream of the point of discontinuity via so-called impulse or differential pressure lines. However, such a coupling may weaken with time, e.g. due to one or more of the impulse lines becoming blocked (clogging, fouling). In some circumstances, however, a weakening coupling is detectable by measurement signals recorded by the pressure sensor. Insofar as the invention therefore relates to a method and a corresponding apparatus for diagnosing an impulse line, i.e. in particular detecting a blockage of one or more impulse lines and/or of deposits on the orifice meter or a diaphragm acting as the interface between the impulse lines and the pressure transducer and/or any diaphragm abrasion, it applies in particular to a method and a corresponding apparatus for analyzing a characteristic value relating thereto in respect of a deviation from or accordance with at least one predefined or predefinable reference value. A weakening or faulty coupling is detectable in this respect e.g. on the basis of a measure for the accordance of the characteristic value with such a reference value or a plurality of such reference values.

Generic methods or devices are generally known. For example, U.S. Pat. No. 5,680,109 discloses using, in addition to a differential pressure transducer, an additional absolute pressure sensor and comparing any measurement noise variance with a reference value. In WO 2001 35174 it is proposed to determine an independent reference signal whose difference with respect to the measurement signal allows any deterioration in the quality of the measurement signal to be gauged. To evaluate the measurement signal, it has been disclosed in U.S. Pat. No. 6,532,392 to compare the measurement signal with a predetermined value of a parameter and to use predefined rules, fuzzy logic or neural networks for the final evaluation. WO 97 36215 discloses determining a statistical parameter of a digitized measurement signal using predefined rules, fuzzy logic or neural networks and then applying a fuzzy membership function to the statistical parameter. Also, U.S. Pat. No. 6,654,697 discloses determining a difference between a digitized measurement signal and the ascertained average value by means of a moving-average algorithm. From this difference, diagnostic data is then determined taking current and historical data into account, a trained data set being calculated from the current and historical data in a training mode. Finally, it is known from U.S. Pat. No. 6,539,267 to calculate a statistical parameter such as variance or rate of change by means of an algorithm and to generate a trained value by means of a microprocessor by monitoring the statistical parameter during normal operation. The trained parameter can be dynamically adapted for different underlying conditions.

Other prior art is described in the following documents: WO 97 48974; JP 2004 354280; U.S. Pat. No. 6,397,411; US 2002 029,130; US 2004 068,392; US 2004 204,883; U.S. Pat. No. 6,701,274; U.S. Pat. No. 5,570,300; U.S. Pat. No. 5,675,724; U.S. Pat. No. 5,665,899; U.S. Pat. No. 5,661,668; U.S. Pat. No. 6,047,220; U.S. Pat. No. 5,956,663; U.S. Pat. No. 5,828,567 and U.S. Pat. No. 5,495,769.

In an older unpublished application of the same applicant there is also disclosed a method and a corresponding apparatus wherein, by means of an analysis device, at least one characteristic value in respect of the, or each, measurement signal is determined and the at least one characteristic value is compared with at least one predefined or predefinable reference value. Then, depending on the result of the comparison, a predefined or predefinable action is initiated. For this purpose an algebraic function is adapted to the measurement signal by means of the analysis device and at least one value of a parameter in respect of at least one segment of the algebraic function is determined by means of the analysis device as a characteristic value. This application can be traced back to the same inventor as the present application and has been submitted under the same title as the present application.

### SUMMARY OF INVENTION

The approaches followed according to the prior art are not quite optimum insofar as they—apart from the above mentioned unpublished application—only take into account a vanishingly small part of the history of the measured values obtained respectively, any time fluctuations often even being averaged. As a result of this and due to a mathematical processing of the measurement signals that is usually provided, e.g. squaring, important information in respect of the phase, i.e. any time offset between a plurality of measurement signals, is lost. Equal history lengths of the measurement signals to be correlated have likewise been used; both of length one or two in each case. Correlation of absolute pressure measurement signals also of the high and low pressure side has not been considered. Instead of this, an instantaneous cross correlation of an absolute pressure measurement signal with a differential pressure measurement signal or an instantaneous autocorrelation of individually recorded measurement signals is taken into account.

An object of the invention accordingly consists in specifying a further embodiment for operating a pressure transducer, in particular for diagnosing an impulse line blockage in a pressure transducer, and a corresponding pressure transducer which in particular avoid the abovementioned disadvantages or at least reduce them in respect of their respective effects.

This object is achieved by a method and a apparatus for carrying out the method according to the claims.

In a method for operating a pressure transducer which is connected by a high-pressure and a low-pressure impulse line to a pipe through which a fluid flows during operation, wherein a pressure sensor incorporated in a pressure transducer supplies at least one measurement signal and wherein, by means of an analysis device, at least one characteristic value relating to the measurement signal is determined, the at least one characteristic value is compared with at least one predefined or predefinable reference value and, depending on the result of the comparison, a predefined or predefinable action is initiated, or in a corresponding method for diagnosing a blockage in at least one impulse line, the following is provided for this purpose: The pressure sensor supplies as the measurement signal a first and second measurement signal. On the basis of the first and second measurement signal, parameters of a model describing a response of the impulse lines are determined using the analysis device. The characteristic value provided for evaluation based on the reference value is produced using at least individual parameters of the model.

The operating or diagnostic method is therefore based on the knowledge that, compared to using comparatively “simple” statistical quantities such as the variance or a two-point correlation, parameters of a transfer function, i.e. of a mathematical relation underlying the respective model, are largely independent of process-induced effects, i.e. instantaneous effects, but highly dependent on the functional state of the transducer and of individual or a plurality of impulse lines. This knowledge is utilized for the operating method or the diagnostic possibility encompassed by the operating method in that such model parameters are determined and a characteristic value designed for evaluating the transducer is derived from one or more of these model parameters. A calculation (estimation) of model parameters or any other way of obtaining such model parameters allows, with known geometry, particularly of the impulse lines, and a given model, a quantitative estimation of the condition of the transducer, the term transducer including at least also the impulse lines, namely e.g. of a blockage diameter of the impulse lines or of a settling time of flow rate measured value. The measurement signals recorded are used as the basis for determining the model parameters. In respect of the measurement signals, the method provides for using at least two measurement signals, so as to satisfactorily take into account the aspect of detecting any time shifts (phase displacement).

Instead of determining characteristic values without phase information between two signals with extremely short signal length, parameters of suitable models for describing the response of the impulse lines are determined or estimated. Models of most diverse order, e.g. a second-order model, come into consideration as models. In addition or alternatively, so-called autoregressive models, AR models, or moving-average models, MA models, or a combination of the two, ARMA models, come into consideration. The relevant model describes a relationship between the two measurement signals, i.e. a differential pressure measurement signal and an absolute pressure measurement signal or two absolute pressure measurement signals, for example. A structure e.g. of an ARMA model is dependent on the physical effects of the fault to be detected. For online identification of a fault, i.e. a blockage, for example, there is determined, on the basis of the estimated model parameters, at least one characteristic value which, because of the underlying model concept, is assigned to a fault type and which permits a physical interpretation.

An advantage of the invention consists in the better evaluation of the information contained in the measurement signals and therefore in a qualitatively improved diagnostic capability. In addition, no test fault needs to be introduced in order to determine a parameter in the case of a measuring point fault. Instead, the parameter is determined on the basis of a predefinable model and geometric variables describing the pressure transducer and/or individual or a plurality of impulse lines or a combination of pressure transducer and the or each impulse line. Moreover, using the estimated model parameters on the basis of the underlying model as well as known geometric variables such as the length of the impulse lines, transducer characteristics, e.g. free diameter of the impulse lines or settling speed until correct indication of the measured value, can be estimated and displayed to an operator.

Another advantage of the invention is that by using transfer models a change in the dynamic response of the impulse lines or of the transducer, e.g. because of blockages, diaphragm abrasion or deposits, can be detected on the basis of a change in the estimated parameters, e.g. diameter of the impulse lines. The response therefore describes a functional state of the transducer, said response being to a large extent independent of the relevant process conditions, so that the respective models and the parameters estimated on this basis are also largely independent of such process conditions. In addition, there exists little uncertainty in respect of the reference value to be used for evaluating the or each characteristic value.

A comparison with other methods which were applied to the measurement signal by a test station has generally shown better results for the approach according to the invention. The compared methods included direct identification of parameters from the measurement signal, such as variance, mean value, skewness and kurtosis, or from the spectrum of the measurement signal and a main component correlation analysis.

The approach generally allows impulse line blockages to be detected largely independently of the operating conditions and permits a physically interpretable characteristic value such as the measured value settling time or remaining pipe diameter to be specified. This enables a reference value to be determined more easily, in some cases without experimental insertion of an artificial blockage. By detecting impulse lines blockage, lines can be cleaned when settling of the measured value takes longer than events to be measured.

The dependent claims relate to preferred embodiments of the present invention. Back-references used in dependent claims relate to further embodiments of the subject matter of the main claim by virtue of the features of the particular dependent claim; they are not to be understood as a waiver of the right to independent, objective protection for the combination of features of the dependent claims to which they refer. In addition, having regard to an interpretation of the claims in the case of a more detailed concretization of a feature in a subordinate claim, it is to be assumed that such a restriction does not exist in the respective preceding claims.

It is preferably provided that the pressure sensor supplies a differential pressure measurement signal and an absolute pressure measurement signal as a first and second measurement signal, the differential pressure measurement signal representing a difference between a pressure in the high-pressure impulse line and a pressure in the low-pressure impulse line and the absolute pressure measurement signal a pressure in the high- or low-pressure impulse line, particularly the high-pressure impulse line. It is alternatively provided that the pressure sensor supplies a first and a second absolute pressure measurement signal representing the pressure in the high- or low-pressure impulse line as the first and second measurement signal.

It can also be provided that the pressure sensor supplies, on the basis of the first and second absolute pressure measurement signal, a differential pressure measurement signal as the first measurement signal and either the first or second absolute pressure measurement signal as the second measurement signal. This has advantages, on the one hand, in that only two pressure measurement signals, namely the two absolute pressure measurement signals, are recorded and also in this respect only two sensors are required, and, on the other, because of a further increased accuracy in applying the method because of the dependency of the first measurement signal on the second measurement signal if namely the first measurement signal is a difference between two absolute pressure measurement signals and the second measurement signal is one of the two absolute pressure measurement signals.

It is preferably further provided that a cutoff frequency or an damping or a gain factor or a comparable physical variable or a comparable parameter is determined as the characteristic value. Such characteristic values are variables which allow a direct physical interpretation and therefore facilitate their evaluation. In addition, such characteristic values can also be made available to an operator, i.e. displayed, for example, as absolute variables for his information in addition to an automatic evaluation by way of comparison with a reference value.

According to an advantageous embodiment of the invention it is provided that a plurality of characteristic values are determined, wherein, for example, comparing a first characteristic value with a relevant reference value enables a conclusion to be drawn in respect of a fault in both impulse lines and comparing a second characteristic value with a relevant reference value enables a conclusion to be drawn in respect of a fault either in one of the two impulse lines or in both impulse lines. By logically combining both conclusions it is then possible to derive a conclusion concerning a fault in one of the two impulse lines. An example may explain this: according to the findings of the invention, as the result of evaluating the damping as characteristic value, a conclusion regarding a blockage in both impulse lines (“both legs blocked” for short) is obtained. In addition, as the result of evaluating the cutoff frequency as the characteristic value, a conclusion regarding a blockage either in one impulse line or in both impulse lines (“one or both legs blocked” for short) is obtained. By logically combining the two results, e.g. such that in the result “one or both legs blocked” all the “both leg blockages” are suppressed, a result in respect of a blockage on one leg is produced. Such a combination can be implemented by logical ANDing, wherein one of the two parameters is negated. Evaluation according to this embodiment of the invention increases the accuracy and/or the informative value of the results obtainable by the diagnostic method or by means of the correspondingly operating transducer.

The claims filed with the application are formulation proposals without prejudice to the obtaining of broader patent protection. The Applicant reserves the right to claim additional combinations of features only disclosed so far in the description and/or drawings.

The or each exemplary embodiment should not be interpreted as a limitation of the invention. On the contrary, within the scope of the present disclosure numerous changes and modifications are possible, especially such variants and, combinations that, for example, as a result of combinations or modifications of individual features or elements or method steps contained in the general description, in the descriptions of various embodiments, and in the claims, and illustrated in the drawing, can be comprehended by persons skilled in the art as far as the achievement of the object is concerned and, as a result of combinable features, lead to a novel article or to novel method steps and/or sequences of method steps.

### BRIEF DESCRIPTION OF THE DRAWINGS

An exemplary embodiment of the invention will now be explained in greater detail with reference to the accompanying drawings. Corresponding objects or elements are provided with the same reference characters in all the figures, in which

FIG. 1 shows a pressure transducer coupled to a pipe through which a fluid flows, and

FIG. 2,

FIG. 3 and

FIG. 4 show diagrams for evaluating characteristic values which are produced from parameters of a model describing a response of the transducer on the basis of measurement signals recorded by the pressure transducer.

### DETAILED DESCRIPTION OF INVENTION

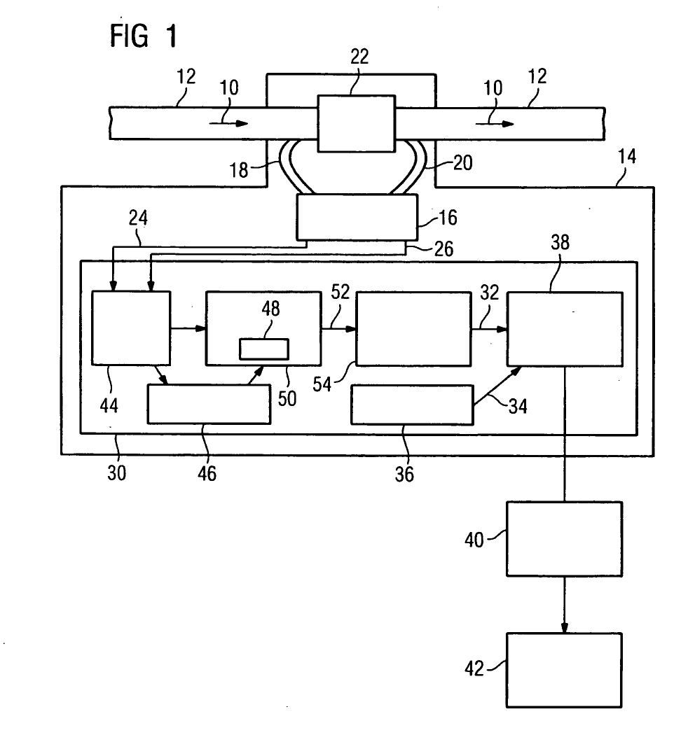

FIG. 1 shows, in schematically simplified form, a pressure transducer 14 coupled to a pipe 12 through which a fluid 10 flows. The pressure transducer 14 incorporates, as a sensing element, a pressure sensor 16 which is coupled to the pipe 12 by means of a first and a second impulse line, hereinafter referred to as the high- and low-pressure impulse line 18, 20, the high-pressure impulse line 18 engaging the pipe 12 e.g. upstream of a point of discontinuity such as a so-called orifice meter 22. The low-pressure impulse line 20 engages the pipe 12 accordingly downstream of the orifice meter 22. It can also be provided that the two impulse lines 18, 20 engage the pipe 12 inside an orifice meter having an orifice plate (not shown). The high-pressure impulse line 18 then engages the pipe 12 upstream of the orifice plate and the low-pressure impulse line 20 downstream of the orifice plate.

The pressure sensor 16 delivers at least one measurement signal 24 in respect of pressure conditions in the region of the orifice meter 22. It is provided that, in addition to the measurement signal 24—hereinafter referred to as a first measurement signal 24—a second measurement signal 26 is supplied by the pressure sensor 16.

In respect of the first and second measurement signal 24, 26 it is provided according to alternative, i.e. essentially equivalent embodiments, that the first and second measurement signal 24, 26 is either a differential pressure measurement signal 24 or an absolute pressure measurement signal 26, the differential pressure measurement signal 24 representing a difference between a pressure in the high-pressure impulse line 18 and a pressure in the low-pressure impulse line 20 and the absolute pressure measurement signal 26 representing the pressure in either the high- or the low-pressure impulse line 18, 20. In the alternative embodiment it is provided that the pressure sensor 16 supplies, as the first and second measurement signal 24, 26, a first and a second absolute pressure measurement signal 24, 26 representing the pressure in the high- or low-pressure impulse line 18,20.

The first and second measurement signal 24, 26 is fed to an analysis device 30 or can be fed to the analysis device 30. The first and second measurement signal 24, 26 is analyzed by the analysis device 30 and at least one characteristic value 32 characterizing the first and second measurement signal 24, 26 is determined and stored in suitable form, output and/or further processed in a manner known per se. In addition to the characteristic value 32, the analysis device 30 also administers at least one predefined or predefinable reference value 34 which is held e.g. in a reference value memory 36 incorporated in the analysis device 30. Possibly using comparing means provided for that purpose, such as a comparator 38, the analysis device 30 compares the characteristic value 32 with the reference value 34 (or a plurality of characteristic values 32 with a reference value 34 or a characteristic value 32 with a plurality of reference values 34 or a plurality of characteristic values 32 with a plurality of reference values 34 and, depending on the result of the comparison, initiates a predefined or predefinable action 40, e.g. outputting of a warning, an output unit 42 or the like possibly being provided for issuing such a warning.

Further details concerning the analysis device 30, i.e. functional units incorporated therein and functionalities associated therewith, will now be explained. According to the embodiment shown in FIG. 1, the analysis device 30 comprises a pre-processing unit 44 which, in addition to digitizing the first and second measurement signal 24, 26, for example, is designed to store a predefined or predefinable number of measured values from the two measurement signals 24, 26, the stored measured values being held in a signal memory 46.

For the further description it will be assumed by way of example that the pressure sensor 16 supplies, as the first measurement signal 24, a differential pressure measurement signal 24 and, as the second measurement signal 26, an absolute pressure measurement signal 26 relating to the high-pressure impulse line 18. As symbols for these two measurement signals 24, 26, the letters d and a respectively are used. A number of stored measured values is denoted by N. Used as the basis for describing a response of impulse lines 18, 20 is a mathematical model 48 which is assigned e.g. to a first functional unit 50 which is designed to determine or estimate parameters of the model 48. In the case of a non-zero second-order model 48 with two poles, as parameters 52 of such a model 48, the variables P₁, P₂, P₃ are determined from a(i−1), d(i), d(i−1) with e.g. i=1 . . . 20 as sampling instants using the following relation:

$$\{ \begin{matrix}{P}_{1} \\ {P}_{2} \\ {P}_{3}\end{matrix} \} = {[ \begin{matrix}{a}^{2} ( i - 1 ) & a ( i - 1 ) a ( i - 2 ) & - a ( i - 1 ) d ( i - 2 ) \\ a ( i - 2 ) a ( i - 1 ) & {a}^{2} ( i - 2 ) & - a ( i - 2 ) d ( i - 2 ) \\ - d ( i - 2 ) a ( i - 1 ) & - d ( i - 2 ) a ( i - 2 ) & {d}^{2} ( i - 2 )\end{matrix} ]}^{- 1} \{ \begin{matrix}- a ( i ) a ( i - 1 ) \\ - a ( i ) a ( i - 2 ) \\ a ( i ) d ( i - 2 )\end{matrix} \}$$

According to “Ljung, L.; System Identification—Theory for the User; Prentice Hall, 2^{nd} Edition 1999”, the parameters 52, i.e. the variables P₁, P₂, P₃, are estimates for the model parameters of a linear, so-called AR model 48, “AR” standing for “autoregressive”. The latter is based on the following mathematical description

a(i)+P₁a(i−1)+P₂a(i−2)=P₃d(i−2)

which is the discretized (with sampling time T) form of the following description of the continuous frequency model 48

(−ω²+2ξω_{g}iω+ω²_{g})A=cD

where A(ω) and D(ω) are the measurement signals 24, 26—a(t), d(t)—transformed to the frequency domain, j the so-called complex unit and ω the signal frequency.

This model 48 results, for example, if one or more variables recorded by the model 48 may be regarded as subject to an inertia Lₕ, a friction component Rₕ and a compliance Cₕ. The variables recorded by the model 48 include in particular the fluid 10 in the or each impulse line 18, 20, the or each impulse line 18, 20, the pressure transducer 14, components incorporated by the pressure transducer 14, such as e.g. the orifice meter 22, etc. These or similar variables are all dependent on the free diameter and the length of the or each impulse line 18, 20 or material properties of the fluid 10, e.g. density or viscosity.

By means of a second functional unit 54, on the basis of the parameters 52 determined by means of the first functional unit 50, one or more characteristic values 32 can be determined as a function of the measurement signals 24, 26. The or each characteristic value 32 is concretely produced on the basis of the measurement signals 24, 26, because the or each parameter 52 describes the response of the impulse lines 18, 20 on the basis of the measurement signals 24, 26 and the or each characteristic value 32 is produced on the basis of at least individual parameters 52.

A physical interpretation can be assigned to the variables

$${ω}_{g} = \frac{{P}_{2} - {P}_{1} + 1}{{T}^{2}} , ξ = \frac{T}{2} \frac{{P}_{1} - 2}{{P}_{2} + 1 - {P}_{1}} , c = {P}_{3}$$

thereby derived from the parameters 52 as characteristic values 32, namely as cutoff frequency ω_{g}, fluid damping in the (respective) impulse line, hereinafter termed damping ξ for short, or gain factor c.

The representation of the pressure transducer 14 shown in FIG. 1 relates to evaluation of the cutoff frequency ω_{g} as the characteristic value 32. The second functional unit 54 is accordingly designed to determine the cutoff frequency ω_{g}. At least one value suitable for evaluating the cutoff frequency ω_{g} is provided in the reference value memory 36 as the reference value 34.

The cutoff frequency ω_{g} is inversely proportional to a duration of a transfer in the impulse line. This duration is a measure for how long it takes for a “steady state condition” to become established as the result of a flow rate change at the pressure transducer 14. For evaluating the characteristic value 32 cutoff frequency ω_{g} a limit value for an estimated settling time can be specified which is only just unacceptable for the relevant application or evaluation case. The settling time or a value which is derived from the settling time and suitable for direct comparison with the cutoff frequency ω_{g} can accordingly be used as the reference value 34.

For other characteristic values 32, i.e. damping ξ or gain factor c, for example, the above statements apply accordingly.

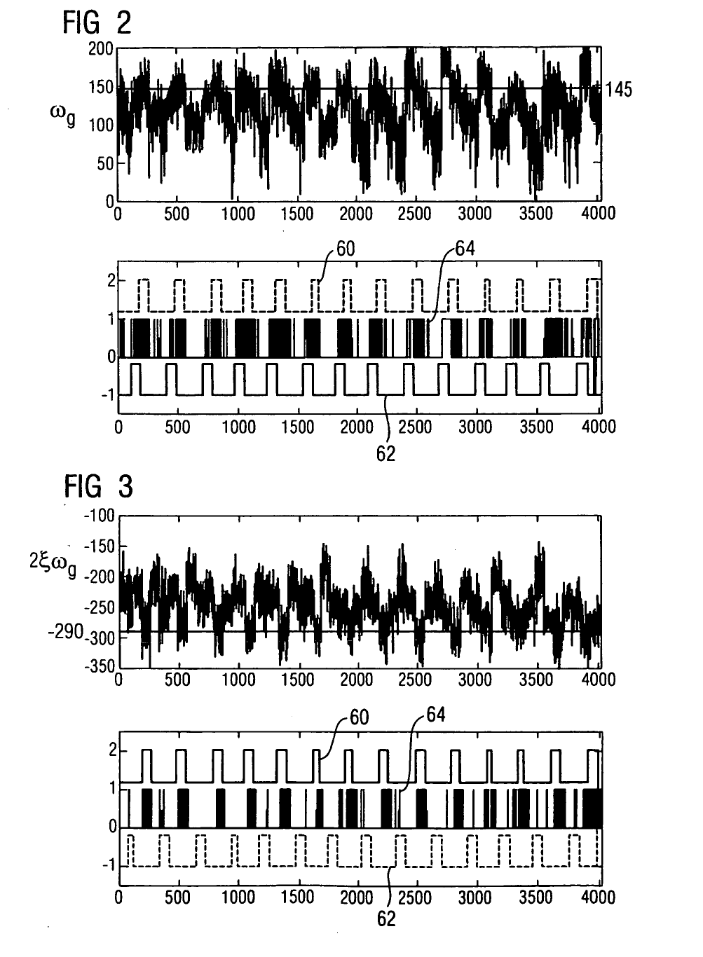

FIG. 2 shows, in the upper diagram, values for the cutoff frequency ω_{g} recorded over time t, the numerical values shown denoting individual sampling points. To evaluate the relevant values for the cutoff frequency ω_{g} as the characteristic value 32, a reference value 34 is provided which is marked on the upper diagram of FIG. 2 as a horizontal line at the position “145”. Whenever the relevant characteristic value 32, i.e. in the case of the diagram in FIG. 2 the cutoff frequency ω_{g}, is greater than the relevant reference value 34, i.e. the value of 145, an initial situation in terms of the response of the impulse lines 18, 20 is present.

The upper diagram in FIG. 2 is the result of a simulation, the general conditions of the simulation being specified in the lower diagram of FIG. 2. For the same time base, the lower diagram in FIG. 2 shows three graphs 60, 62, 64, an upper graph 60 at a “High level” indicating blockage of both impulse lines 18, 20 and a lower graph 62 blockage of the high-pressure impulse line 18. The blockage either of both impulse lines 18, 20 or of the high-pressure impulse line 18 is produced for test purposes as part of the simulation. The middle graph 64 of FIG. 2 shows a result of a possible evaluation on the basis of consideration of the cutoff frequency ω_{g}. Whenever the middle graph 64 shows a “High level”, evaluation of the cutoff frequency ω_{g} indicates a detected blockage of at least one impulse line 18, 20 in consideration of the respective reference value 34. On the basis of a comparison of the graphs 60-64 shown in the lower diagram of FIG. 2 it emerges that either a blockage of the high-pressure impulse line 18 or a blockage of both impulse lines 18, 20 is very clearly identifiable by evaluating the cutoff frequency ω_{g} as the characteristic value 32. Only isolated mis-evaluations occur, e.g. in the region of t=300, t=2700 and t=3800.

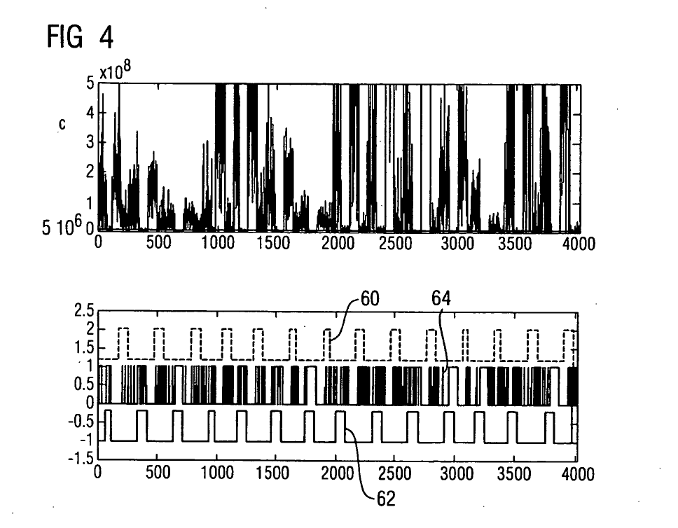

FIG. 3 shows a diagram similar to that in FIG. 2. It differs from the diagram in FIG. 2 in that, in the upper part of FIG. 3, the damping ξ is now plotted as 2ξω_{g} as the characteristic value 32. Also for such a characteristic value 32, an associated reference value 34 is provided for its evaluation. The reference value 34 is marked as a horizontal line at “−290”. The three graphs 60-64 in the lower diagram in FIG. 3 again describe (analogously to the conditions already explained in connection with FIG. 2) the underlying situation according to the simulation, the upper graph 60 indicating the instants at which both impulse lines 18, 20 are blocked and the lower graph 62 indicating the instants at which the high-pressure impulse line 18 is blocked. The middle graph 64 indicates when, on the basis of an evaluation of the damping ξ as the limit value 32, blockage is detected in consideration of the underlying reference value 34 at “−290”. Because of using N measured values, detection takes place, as also in FIG. 2, in a somewhat time-delayed manner. As is also the case in the diagram in FIG. 2, there are a shall number of positions at which mis-evaluations occur on the basis of evaluating the damping ξ as the characteristic value 32. This is the case in the situation shown, e.g. in the region of t=2000 and t=3400.

FIG. 4 shows a diagram similar to those shown in FIG. 2 and FIG. 3 on the same time base. The diagram in FIG. 4 relates to an evaluation of the gain factor c as the characteristic value 32. The characteristic value 32 is assigned, as the reference value 34, the numerical value “5×10⁶”. The lower diagram in FIG. 4 describes the underlying conditions generated in the simulation, i.e. on the basis of the upper graph 60 instants at which both impulse lines 18, 20 are blocked, and on the basis of the lower graph 62 instants at which the high-pressure impulse line 18 is blocked. The middle graph 64 again indicates the result of the evaluation of the gain factors c as the characteristic value 32. A small number of mis-evaluations also occur in this evaluation, e.g. in the region of t=300, t=600, t=900, t=2300, t=3600 and t=3700.

Evaluation of the damping ξ as the characteristic value 32 produces a result indicating that both impulse lines 18, 20 are blocked (see FIG. 3). Evaluation of the cutoff frequency ω_{g} as the characteristic value 32 (see FIG. 2) produces a result indicating either both legs blocked or one leg blocked, i.e. blockage of the high-pressure impulse line 18 in the case of an absolute pressure signal 26 relating to the high-pressure impulse line 18. By logically combining the result “both legs blocked” of the evaluation according to FIG. 2 with the result “both legs or one leg blocked” of the evaluation according to FIG. 3, a result indicating a single leg blocked condition can be obtained.

A corresponding result can be obtained if, instead of the result of the evaluation according to FIG. 2, the result of the evaluation according to FIG. 4, which likewise indicates both legs or one leg blocked, together with an evaluation of the situation according to FIG. 3 is used as the basis.

The invention may therefore be summarized as follows: a method for detecting or diagnosing an impulse line blockage in a pressure transducer 14 and a corresponding pressure transducer 14 are specified, wherein to analyze at least one measurement signal 24, 26 at least one characteristic value 32 is compared with at least one reference value 34 and, depending on the result of the comparison, an action 40 is initiated, the or each characteristic value 32 being produced on the basis of at least individual parameters 52 of a model 48 describing a response of impulse lines 18, 20 by which the pressure transducer 14 is coupled to a pipe 12 through which a fluid 10 flows.

1.-9. (canceled)

10. A method for operating a pressure transducer which is connected to a pipe at least by a high-pressure and a low-pressure impulse line, comprising:
supplying a first measurement signal and a second measurement signal by a pressure sensor incorporated by the pressure transducer;
determining a characteristic value in relation to the first and second measurement signal by an analysis device, wherein parameters of a model describing a response of the high-pressure and the low-pressure impulse lines are determined based upon the first and second measurement signal and the characteristic value is produced based upon individual parameters;
comparing the characteristic value with a predefined reference value by the analysis device; and
initiating a predefined action depending on the result of the comparison by the analysis device.

11. The method as claimed in claim 10, wherein the pressure sensor supplies a differential pressure measurement signal as the first measurement signal and an absolute pressure measurement signal as the second measurement signal, the differential pressure measurement signal representing a difference between a pressure in the high-pressure impulse line and a pressure in the low-pressure impulse line and the absolute pressure measurement signal representing the pressure in the high- or low-pressure impulse line.

12. The method as claimed in claim 10, wherein the pressure sensor supplies a first and a second absolute pressure measurement signal as the first and second measurement signal which represent a pressure in the high-pressure impulse line and the low-pressure impulse line respectively.

13. The method as claimed in claim 12, wherein the pressure sensor supplies a differential pressure measurement signal as the first measurement signal and either the first or second absolute pressure measurement signal as the second measurement signal.

14. The method as claimed in claim 10, wherein a cutoff frequency or a damping or a gain factor is determined as the characteristic value.

15. The method as claimed in claim 11, wherein a cutoff frequency or a damping or a gain factor is determined as the characteristic value.

16. The method as claimed in claim 12, wherein a cutoff frequency or a damping or a gain factor is determined as the characteristic value.

17. The method as claimed in claim 14, wherein a plurality of characteristic values are determined, a comparison of a first characteristic value with a respective reference value enabling a conclusion to be drawn in respect of a fault in both impulse lines and a comparison of a second characteristic value with a respective reference value enabling a conclusion to be drawn in respect of a fault either in one of the two impulse lines or in both impulse lines, wherein a logical combination of both conclusions produces a conclusion concerning a fault in one of the two impulse lines.

18. A pressure transducer connected to a pipe by at least one high- and low-pressure impulse line, comprising:
a pressure sensor for delivering a first measurement signal and a second measurement signal; and
an analysis device for
determining a characteristic value relating to the first and second measurement signal, wherein parameters of a model describing a response of the high-pressure and the low-pressure impulse lines are determined by the analysis device based upon the first and second measurement signal, and wherein the characteristic value is produced based upon individual parameters,
comparing the characteristic value with a predefined reference value, and
initiating a predefined action depending on the result of the comparison.

19. The pressure transducer as claimed in claim 18, wherein the pressure sensor supplies a differential pressure measurement signal as the first measurement signal and an absolute pressure measurement signal as the second measurement signal, the differential pressure measurement signal representing a difference between a pressure in the high-pressure impulse line and a pressure in the low-pressure impulse line and the absolute pressure measurement signal representing the pressure in the high- or low-pressure impulse line.

20. The pressure transducer as claimed in claim 18, wherein the pressure sensor supplies a first and a second absolute pressure measurement signal as the first and second measurement signal which represent a pressure in the high-pressure impulse line and the low-pressure impulse line respectively.

21. The pressure transducer as claimed in claim 20, wherein the pressure sensor supplies a differential pressure measurement signal as the first measurement signal and either the first or second absolute pressure measurement signal as the second measurement signal.

22. The pressure transducer as claimed in claim 18, wherein a cutoff frequency or a damping or a gain factor is determined as the characteristic value.

23. The pressure transducer as claimed in claim 22, wherein a plurality of characteristic values are determined, a comparison of a first characteristic value with a respective reference value enabling a conclusion to be drawn in respect of a fault in both impulse lines and a comparison of a second characteristic value with a respective reference value enabling a conclusion to be drawn in respect of a fault either in one of the two impulse lines or in both impulse lines, wherein a logical combination of both conclusions produces a conclusion concerning a fault in one of the two impulse lines.

24. A computer readable medium storing a computer program with computer-executable program code instructions which, when executed on a computer system, perform a method, comprising:
supplying a first measurement signal and a second measurement signal by a pressure sensor incorporated by a pressure transducer which is connected to a pipe at least by a high-pressure and a low-pressure impulse line;
determining a characteristic value in relation to the first and second measurement signal by an analysis device, wherein parameters of a model describing a response of the high-pressure and the low-pressure impulse lines are determined based upon the first and second measurement signal and that the characteristic value is produced based upon individual parameters;
comparing the characteristic value with a predefined reference value by the analysis device; and
initiating a predefined action depending on the result of the comparison by the analysis device.

25. The computer readable medium as claimed in claim 24, wherein the pressure sensor supplies a differential pressure measurement signal as the first measurement signal and an absolute pressure measurement signal as the second measurement signal, the differential pressure measurement signal representing a difference between a pressure in the high-pressure impulse line and a pressure in the low-pressure impulse line and the absolute pressure measurement signal representing the pressure in the high- or low-pressure impulse line.

26. The computer readable medium as claimed in claim 24, wherein the pressure sensor supplies a first and a second absolute pressure measurement signal as the first and second measurement signal which represent a pressure in the high-pressure impulse line and the low-pressure impulse line respectively.

27. The computer readable medium as claimed in claim 26, wherein the pressure sensor supplies a differential pressure measurement signal as the first measurement signal and either the first or second absolute pressure measurement signal as the second measurement signal.

28. The computer readable medium as claimed in claim 24, wherein a cutoff frequency or a damping or a gain factor is determined as the characteristic value.

29. The computer readable medium as claimed in claim 28, wherein a plurality of characteristic values are determined, a comparison of a first characteristic value with a respective reference value enabling a conclusion to be drawn in respect of a fault in both impulse lines and a comparison of a second characteristic value with a respective reference value enabling a conclusion to be drawn in respect of a fault either in one of the two impulse lines or in both impulse lines, wherein a logical combination of both conclusions produces a conclusion concerning a fault in one of the two impulse lines.
